(19) United States
(12) Patent Application Publication
(10) Pub. No.: US 2026/0298772 A1
(43) Pub. Date: Oct. 1, 2026

(54) QUALITY EVALUATION DEVICE, QUALITY EVALUATION METHOD, AND QUALITY EVALUATION PROGRAM FOR ROTARY MACHINE

(71) Applicant: MITSUBISHI HEAVY INDUSTRIES, LTD., Tokyo (JP)

(72) Inventors: Yuta Imai, Tokyo (JP); Satoshi Kumagai, Tokyo (JP); Masahiko Yamashita, Tokyo (JP); Yoshinori Tanaka, Tokyo (JP)

(73) Assignee: MITSUBISHI HEAVY INDUSTRIES, LTD., Tokyo (JP)

(21) Appl. No.: 19/480,098

(22) PCT Filed: Feb. 27, 2024
(86) PCT No.: PCT/JP2024/006901

§ 371 Date: Oct. 30, 2025

(30) Foreign Application Priority Data
May 18, 2023 (JP) 2023-082386

(51) Int. Cl. G01M 13/028; G01H 1/00; G01M 13/005

(52) U.S. Cl. CPC G01M 13/028; G01H 1/003; G01M 13/005

(57) ABSTRACT

This quality evaluation device evaluates the quality of a rotary machine having a rotation unit that is supported by a bearing rotatably with respect to a stationary unit. The device acquires an AE signal from at least one AE sensor provided in the stationary unit, and calculates a rubbing detection index on the basis of the AE signal. The device then estimates the amount of wear of the rotary machine by integrating the rubbing detection index.

### TECHNICAL FIELD

The present disclosure relates to a quality evaluation device, a quality evaluation method, and a quality evaluation program for a rotary machine.

The present application claims priority based on Japanese Patent Application No. 2023-082386 filed in Japan on May 18, 2023, the contents of which are incorporated herein by reference.

### BACKGROUND ART

In a rotary machine including a rotary portion that is rotatable with respect to a stationary portion, such as a steam turbine, there is a possibility that rubbing in which a rotary body comes into contact with the stationary portion occurs due to a reduction in a gap between the stationary portion and the rotary portion caused by thermal deformation of a casing during operation. The rubbing occurrence causes wear on components of the rotary machine and is a factor that causes performance degradation due to an increase in shaft vibration or a gap increase.

As a technique for determining such rubbing occurrence, a method using an acoustic emission (AE) sensor capable of detecting an AE signal generated during the rubbing is known. For example, in PTL 1, it is possible to determine the presence or absence of rubbing occurrence based on information related to a phase of an AE signal. In addition, in PTL 2, it is possible to specify an occurrence position of rubbing in addition to the presence or absence of rubbing occurrence, based on an AE signal detected by a plurality of AE sensors disposed at different positions.

### CITATION LIST

### Patent Literature

[PTL 1] Japanese Unexamined Patent Application Publication No. 2021-76533
[PTL 2] Japanese Unexamined Patent Application Publication No. 2022-151125

### SUMMARY OF INVENTION

### Technical Problem

In PTL 1 and PTL 2, it is possible to determine the presence or absence of rubbing occurrence or a rubbing occurrence position based on the AE signal. All of these methods are for determining instantaneous rubbing, and it is not possible to evaluate the degree of damage caused by accumulation of wear caused by the rubbing. As described above, rubbing occurrence causes wear on components of the rotary machine, and thus maintenance such as replacement of the components is required according to the degree of progress of the wear. In this type of maintenance, it is necessary to open a casing to access an inside of the rotary machine, which requires time or costs. Therefore, it is desirable to perform component replacement for only a necessary portion at a necessary time. Ascertaining of a wear amount in the rotary machine caused by rubbing is useful information for specifying a time of such maintenance and a target portion, and is expected to reduce waiting time or costs for securing components by preparing replacement components in advance.

At least one embodiment of the present disclosure has been made in view of the circumstances described above, and an object of the present disclosure is to provide a quality evaluation device, a quality evaluation method, and a quality evaluation program for a rotary machine capable of appropriately evaluating a quality of the rotary machine by estimating a wear amount of the rotary machine based on an AE signal.

### Solution to Problem

In order to solve the above problems, according to at least one embodiment of the present disclosure, there is provided a quality evaluation device for a rotary machine for evaluating a quality of the rotary machine having a rotary portion that is rotatably supported to a stationary portion by a bearing, the device including: an AE signal acquisition unit for acquiring an AE signal from at least one AE sensor provided at the stationary portion; a rubbing detection index calculation unit for calculating a rubbing detection index based on the AE signal; and a wear amount estimation unit for estimating a wear amount of the rotary machine by integrating the rubbing detection index.

In order to solve the above problems, according to at least another embodiment of the present disclosure, there is provided a quality evaluation method for a rotary machine for evaluating a quality of the rotary machine having a rotary portion that is rotatably supported to a stationary portion by a bearing, the method including: a step of acquiring an AE signal from at least one AE sensor provided at the stationary portion; a step of calculating a rubbing detection index based on the AE signal; and a step of estimating a wear amount of the rotary machine by integrating the rubbing detection index.

In order to solve the above problems, according to at least still another embodiment of the present disclosure, there is provided a quality evaluation program for a rotary machine for evaluating a quality of the rotary machine having a rotary portion that is rotatably supported to a stationary portion by a bearing, the program causing a computer device to execute: a step of acquiring an AE signal from at least one AE sensor provided at the stationary portion; a step of calculating a rubbing detection index based on the AE signal; and a step of estimating a wear amount of the rotary machine by integrating the rubbing detection index.

### Advantageous Effects of Invention

According to at least one embodiment of the present disclosure, it is possible to provide a quality evaluation device, a quality evaluation method, and a quality evaluation program for a rotary machine capable of appropriately evaluating a quality of the rotary machine by estimating a wear amount of the rotary machine based on an AE signal.

### BRIEF DESCRIPTION OF DRAWINGS

FIG. 1 is a cross-sectional structure diagram of a rotary machine according to an embodiment.

FIG. 2 is a configuration block diagram of a quality evaluation device in FIG. 1.

FIG. 3 is an explanatory diagram illustrating an example of an estimation calculation method of a wear amount by a wear amount estimation unit in FIG. 2.

FIG. 4 is an explanatory diagram illustrating another example of the estimation calculation method of the wear amount by the wear amount estimation unit in FIG. 2.

FIG. 5 is a flowchart illustrating a quality evaluation method according to the embodiment.

FIG. 6 is a cross-sectional structure diagram of a rotary machine according to another embodiment.

FIG. 7 is a cross-sectional structure diagram of a rotary machine according to still another embodiment.

FIG. 8 is a cross-sectional structure diagram of a rotary machine according to still another embodiment.

FIG. 9 is a cross-sectional structure diagram of a rotary machine according to still another embodiment.

FIG. 10 is a schematic view illustrating an enlarged view of a peripheral configuration of a low-pressure unit in FIG. 6.

FIG. 11 is a diagram illustrating a signal intensity distribution obtained in a case where an impact is applied to each target portion in FIG. 10.

FIG. 12 is an example of calculating a weighting coefficient based on a signal intensity in FIG. 11.

FIG. 13 is a diagram illustrating an example of an estimation value of the wear amount for each target portion of a rotary machine 1.

FIG. 14 is an explanatory diagram illustrating a state in which a reference value for determining whether maintenance is required is determined from an existing inspection result.

FIG. 15 is an explanatory diagram illustrating a correction example of the weighting coefficient based on an inspection result.

### DESCRIPTION OF EMBODIMENTS

Hereinafter, some embodiments of the present disclosure will be described with reference to the accompanying drawings. Meanwhile, dimensions, materials, shapes, and relative dispositions of configurations described as the embodiments or illustrated in the drawings are not intended to limit the scope of the present disclosure, and are merely examples for describing the present disclosure.

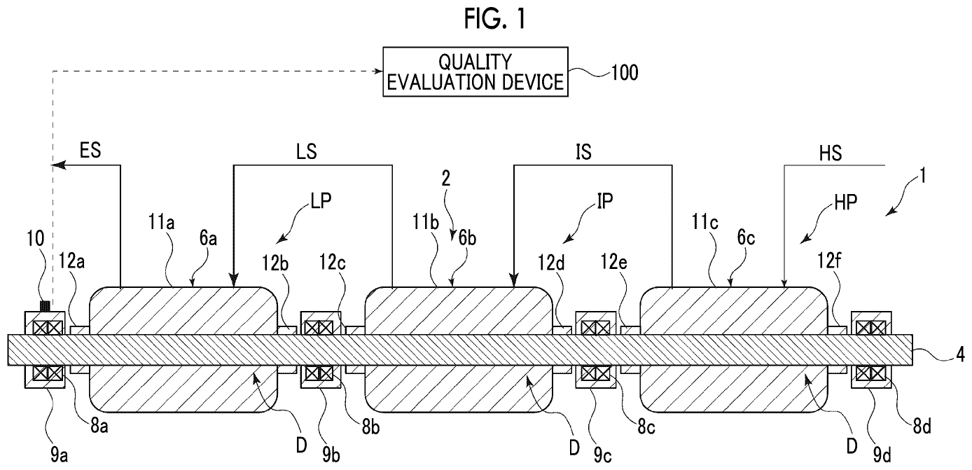

FIG. 1 is a cross-sectional structure diagram of a rotary machine 1 according to the embodiment. The rotary machine 1 includes a stationary portion 2 and a rotary portion 4 that is rotatable with respect to the stationary portion 2. In the present embodiment, a steam turbine capable of driving the rotary portion 4 with a working fluid of steam will be described as an example of the rotary machine 1. However, the rotary machine 1 is not limited thereto.

The rotary machine 1 includes a high-pressure unit HP, an intermediate-pressure unit IP, and a low-pressure unit LP that can be driven by using steam as a working fluid. High-pressure steam HS is supplied from an outside to the rotary machine 1 as a working fluid. The high-pressure steam HS is first supplied to the high-pressure unit HP. The high-pressure steam HS that has performed work on the high-pressure unit HP becomes intermediate-pressure steam IS due to a decrease in pressure, and is supplied to the intermediate-pressure unit IP. The intermediate-pressure steam IS that has performed work on the intermediate-pressure unit IP becomes low-pressure steam LS due to a decrease in pressure, and is supplied to the low-pressure unit LP. The low-pressure steam LS that has performed work on the low-pressure unit LP becomes exhaust steam ES due to a decrease in pressure, and is discharged to the outside.

The high-pressure unit HP, the intermediate-pressure unit IP, and the low-pressure unit LP have the rotary portion 4, which is a rotor, in common, and have casings 6a to 6c which are the corresponding stationary portions 2, respectively. A gap D (not illustrated) (more specifically, the gap D is mainly formed between an innermost peripheral portion of a stator vane provided at the casings 6a to 6c and an outermost peripheral portion (tip) of a rotor blade provided at the rotary portion 4, and may reach between the casings 6a to 6c to which the stator vane is attached and the rotary portion 4 to which the rotor blade is attached) is provided between the rotary portion 4 and the casings 6a to 6c in each unit. The rotary portion 4 is driven by introducing each working fluid into the gap D as described above. During an operation of the rotary machine 1, at least one of the stationary portion 2 or the rotary portion 4 is deformed due to an influence of heat or the like, and thus the gap D may be reduced, and rubbing may occur. Such rubbing can be detected based on an AE signal detected by an AE sensor 10 to be described later.

In addition, the casings 6a to 6c have end portions 12a to 12f (so-called cat feet) in which both sides in an axial direction are formed to have a smaller size in a radial direction than central portions 11a to 11c. The end portions 12a to 12f constitute the casings 6a to 6c which are the stationary portions 2 integrally with the central portions 11a to 11c.

In addition, the rotary machine 1 has bearings 8a to 8d (radial bearings) for supporting the rotary portion 4. The bearing 8a rotatably supports an end portion of the rotary portion 4 on the low-pressure unit LP side. The bearing 8b rotatably supports the low-pressure unit LP and the intermediate-pressure unit IP of the rotary portion 4.

The bearing 8c rotatably supports the intermediate-pressure unit IP and the high-pressure unit HP in the rotary portion 4. The bearing 8d rotatably supports an end portion of the rotary portion 4 on the high-pressure unit HP side. The bearings 8a to 8d are accommodated in bearing boxes 9a to 9d, respectively.

The AE sensor 10 is configured to detect an acoustic emission (AE) signal, and is provided at the stationary portion 2 of the rotary machine 1. In FIG. 1, a case where the AE sensor 10 is provided at the bearing box 9a is illustrated as a representative disposition example. However, as will be described later, the AE sensor 10 may be provided at other bearing boxes 9b to 9d or may be provided at the casings 6a to 6c. For example, in the rotary machine 1, rubbing occurs between the rotary portion 4 and a seal or the like attached to the stationary portion 2 where thermal deformation has occurred, thereby generating an AE wave. For example, an AE wave generated at a rubbing occurrence location propagates, as an elastic wave, through the stationary portion 2 and the rotary portion 4, and is detected as the AE signal by the AE sensor 10 installed in the rotary machine 1. The AE wave generally has a frequency in a sound wave region of several tens of kHz to several MHz.

Subsequently, a quality evaluation device 100 for evaluating a quality of the rotary machine 1 having the configuration described above will be described. For example, the quality evaluation device 100 is configured to include a central processing unit (CPU), a random-access memory (RAM), a read-only memory (ROM), and a computer-readable storage medium. A series of processing for realizing various functions is stored in a storage medium or the like in the form of a program, as an example, and the CPU reads out the program to the RAM or the like, and executes processing for information and calculation processing, whereby various functions are realized. A form installed in advance in the ROM or other storage medium, a form provided in a state of being stored in a computer-readable storage medium, or a form of being delivered via wired or wireless communication means may be applied as the program. The computer-readable storage medium is a magnetic disk, a magneto-optical disk, a CD-ROM, a DVD-ROM, a semiconductor memory, or the like.

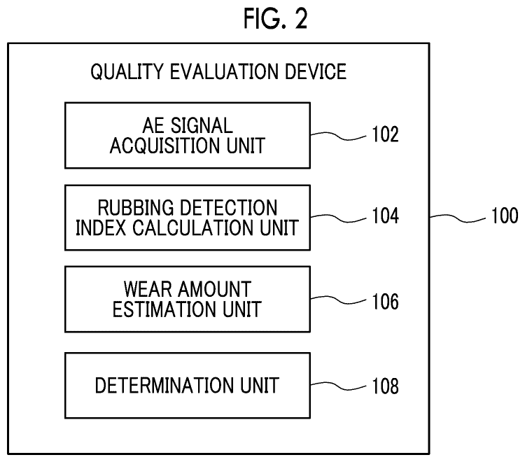

FIG. 2 is a configuration block diagram of the quality evaluation device 100 in FIG. 1. The quality evaluation device 100 includes an AE signal acquisition unit 102, a rubbing detection index calculation unit 104, a wear amount estimation unit 106, and a determination unit 108.

The AE signal acquisition unit 102 is configured to acquire an AE signal. As described above, the AE sensor 10 is attached to the stationary portion 2 of the rotary machine 1, and the AE signal acquisition unit 102 acquires the AE signal detected by the AE sensor 10.

The rubbing detection index calculation unit 104 is configured to calculate a rubbing detection index a based on the AE signal acquired by the AE signal acquisition unit 102. For example, the rubbing detection index a is calculated based on information on a phase of the AE signal. Specifically, the rubbing detection index a is calculated by the following equation.

Rubbing detection index=1/(1+(variance in phase of AE signal)\hat{ }0.5) Equation (1)

For example, the AE signal detected by the AE sensor 10 includes a noise signal from the rotary portion 4 to some extent during the operation of the rotary machine 1. Even in a case where the noise signal is relatively large, the presence or absence of rubbing occurrence can be appropriately determined by using the rubbing detection index a calculated based on the information on the phase of the AE signal.

A detailed calculation method of the rubbing detection index a exemplified in Equation (1) described above follows PTL 1.

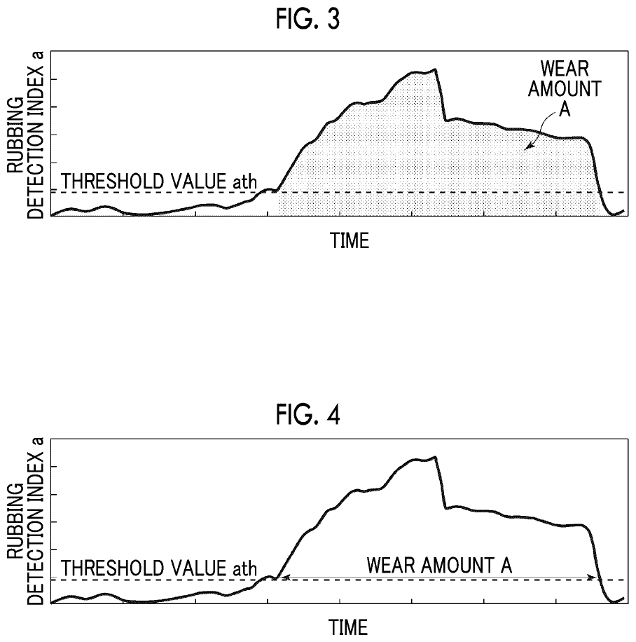

The wear amount estimation unit 106 is configured to estimate a wear amount A of the rotary machine 1 by integrating the rubbing detection index a calculated by the rubbing detection index calculation unit 104. Here, some specific examples of an estimation calculation method of the wear amount A by the wear amount estimation unit 106 in FIG. 2 will be described with reference to FIGS. 3 and 4. FIG. 3 is an explanatory diagram illustrating an example of an estimation calculation method of the wear amount A by the wear amount estimation unit 106 in FIG. 2, and FIG. 4 is an explanatory diagram illustrating another example of the estimation calculation method of the wear amount A by the wear amount estimation unit 106 in FIG. 2.

In the example illustrated in FIG. 3, the wear amount estimation unit 106 estimates the wear amount A by integrating over a region in which the rubbing detection index a exceeds a preset threshold value ath. The threshold value ath is set in advance as a reference value for determining the presence or absence of instantaneous rubbing occurrence based on the rubbing detection index a. That is, the region in which the rubbing detection index a exceeds the threshold value ath is a time period in which rubbing occurs, and a region in which the rubbing detection index a is equal to or less than the threshold value ath is a time period in which rubbing does not occur. The wear amount estimation unit 106 can estimate the wear amount A using the following equation by integrating the rubbing detection index a(t) at a certain time t over the former region.

$$A = \int {a}^{′} ( t ) dt , {a}^{′} ( t ) = \{ \begin{matrix}0 & for a ( t ) < {a}_{th} \\ a ( t ) & for a ( t ) ≧ {a}_{th}\end{matrix} \qquad Equation ( 2 )$$

In addition, in the example illustrated in FIG. 4, the wear amount estimation unit 106 estimates the wear amount A by integrating the time in which the rubbing detection index a exceeds the preset threshold value ath. Specifically, the wear amount A is estimated by the following equation.

$$A = \int f ( t ) dt , f ( t ) = \{ \begin{matrix}0 & for a ( t ) < {a}_{th} \\ 1 & for a ( t ) ≧ {a}_{th}\end{matrix} \qquad Equation ( 3 )$$

The determination unit 108 is configured to determine whether maintenance of the rotary machine 1 is required, by comparing the wear amount A estimated by the wear amount estimation unit 106 with a preset reference value Aref. In the determination unit 108, the wear amount A quantitatively calculated by the integration of the rubbing detection index a is compared with the preset reference value Aref. As a result, in a case where it is determined that the wear amount A of the rotary machine 1 is sufficiently large since the wear amount A exceeds the reference value Aref, it is possible to appropriately determine that the maintenance of the rotary machine 1 is required.

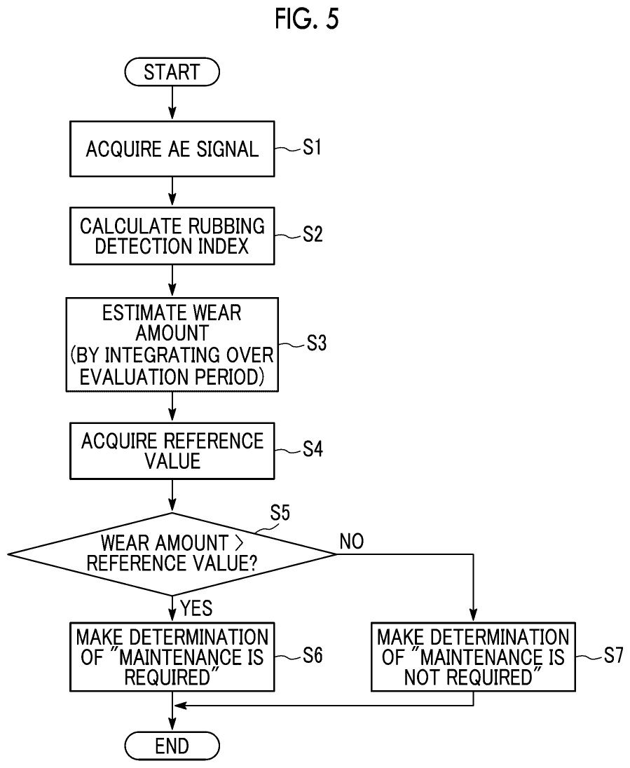

Subsequently, a quality evaluation method performed by the quality evaluation device 100 having the configuration described above will be described. FIG. 5 is a flowchart illustrating a quality evaluation method according to the embodiment.

When the quality evaluation method is started, first, the AE signal acquisition unit 102 acquires an AE signal detected by the AE sensor 10 (step S1). Subsequently, the rubbing detection index a is calculated by the rubbing detection index calculation unit 104 based on the AE signal acquired in step S1 (step S2). The acquisition of the AE signal in step S1 is continuously performed over time according to a predetermined sampling cycle, and in step S2, the rubbing detection index a is calculated based on each AE signal.

Subsequently, the wear amount estimation unit 106 estimates the wear amount A by integrating the rubbing detection index a calculated in step S2 over an evaluation period (step S3). As described above, the rubbing detection index a is continuously calculated over time, and in step S3, an estimation value of the wear amount A is obtained by integrating the rubbing detection index a over a predetermined evaluation period set in advance. The method for calculating the estimation value of the wear amount A is as described above.

Subsequently, the determination unit 108 acquires the reference value Aref corresponding to the wear amount A (step S4). The reference value Aref is a threshold value for determining whether maintenance is required, and is determined by evaluating the wear amount A that requires maintenance in advance experimentally, theoretically, or by simulation. The reference value Aref is stored in advance in a storage device (not illustrated) in a readable manner, for example.

Subsequently, the determination unit 108 determines whether or not the wear amount A estimated in step S3 is more than the reference value Aref acquired in step S4 (step S5). In a case where the wear amount A is more than the reference value Aref (YES in step S5), the determination unit 108 makes a determination of “maintenance is required” based on the fact that the degree of progress of wear is large (step S6). On the other hand, in a case where the wear amount A is equal to or less than the reference value Aref (NO in step S5), the determination unit 108 makes a determination of “maintenance is not required” since the degree of progress of wear is small (step S7).

In steps S6 and S7, a predetermined output (for example, a screen display, voice, or the like) may be performed according to the determination result.

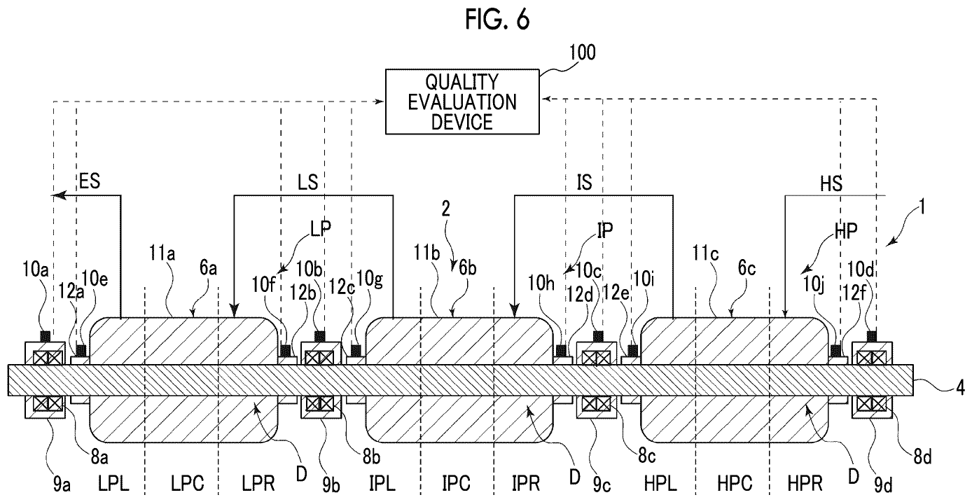

FIG. 6 is a cross-sectional structure diagram of a rotary machine according to another embodiment. This embodiment is different from the embodiment illustrated in FIG. 1 in that each of a plurality of AE sensors 10 is provided at each of the bearing boxes 9a to 9d and the end portions 12a to 12f. More specifically, among the plurality of AE sensors 10, AE sensors 10a to 10d are respectively provided at the bearing boxes 9a to 9d, and AE sensors 10e to 10j are respectively provided at the end portions 12a to 12f. Each of the AE sensors 10 has the same configuration, and an AE signal detected by each AE sensor 10 can be acquired by the quality evaluation device 100.

In addition, in the embodiment illustrated in FIG. 6, a target portion at which a wear amount is to be estimated is set by dividing each of the casings 6a to 6c, which is the stationary portion 2, into three. Specifically, a left side portion LPL, a central portion LPC, and a right side portion LPR are set as target portions in the casing 6a, a left side portion IPL, a central portion IPC, and a right side portion IPR are set as target portions in the casing 6b, and a left side portion HPL, a central portion HPC, and a right side portion HPR are set as target portions in the casing 6c.

The wear amount estimation unit 106 may estimate a wear amount A′ at each target portion by adding the wear amount A estimated by using each AE sensor 10 with a predetermined weighting coefficient. Specifically, the wear amount A′ in each target portion is represented by the following equations using wear amounts Aa to Aj estimated based on AE signals from the AE sensors 10a to 10j and corresponding weighting coefficients αa to αj.

$$Equation ( 4 - 1 )$$

$$Wear amount {A}^{′} of target portion LPL = α a ( = 0.5 ) \times Aa + α e ( = 1. ) \times Ae$$

$$Equation ( 4 - 2 )$$

$$Wear amount {A}^{′} of target portion LPC = α a ( = 0.5 ) \times Aa + α b ( = 0.25 ) \times Ab$$

$$Equation ( 4 - 3 )$$

$$Wear amount {A}^{′} of target portion LPR = α b ( = 0.25 ) \times Ab + α f ( = 1. ) \times Af$$

$$Equation ( 4 - 4 )$$

$$Wear amount {A}^{′} of target portion IPL = α b ( = 0.25 ) \times Ab + α g ( = 1. ) \times Ag$$

$$Equation ( 4 - 5 )$$

$$Wear amount {A}^{′} of target portion IPC = α b ( = 0.25 ) \times Ab + α c ( = 0.25 ) \times Ac$$

$$Equation ( 4 - 6 )$$

$$Wear amount {A}^{′} of target portion IPR = α c ( = 0.25 ) \times Ac + α h ( = 1. ) \times Ah$$

$$Equation ( 4 - 7 )$$

$$Wear amount {A}^{′} of target portion HPL = α c ( = 0.25 ) \times Ac + α i ( = 1. ) \times Ai$$

$$Equation ( 4 - 8 )$$

$$Wear amount {A}^{′} of target portion HPC = α c ( = 0.25 ) \times Ac + α d ( = 0.5 ) \times Ad$$

$$Equation ( 4 - 9 )$$

$$Wear amount {A}^{′} of target portion HPR = α d ( = 0.5 ) \times Ad + α j ( = 1. ) \times Aj$$

Each of the weighting coefficients αa to αj for each target portion is normalized such that each total is a predetermined value (for example, “1”).

The wear amount A′ of the target portion (LPL, LPR, IPL, IPR, HPL, HPR) biased to one side with respect to the central portion (LPC, IPC, HPC) of each of the casings 6a to 6c among the target portions is obtained by adding the wear amount A calculated by using a first AE sensor provided at a bearing box which accommodates a bearing at a position closest to the target portion and the second AE sensor provided at an end portion of a casing between the target portion and the bearing box, by using a predetermined weighting coefficient α. In each of Equations (4-1), (4-3), (4-4), (4-6), (4-7), and (4-9) described above, the first term indicates a wear amount corresponding to the first AE sensor, and the second term indicates a wear amount corresponding to the second AE sensor. The first AE sensor is provided at a bearing box which accommodates a bearing at a position closest to the target portion, and is an AE sensor that has the greatest influence on the target portion. Since the second AE sensor is also provided at an end portion closest to the target portion, the influence on the target portion is great. In this manner, the wear amount A′ at the target portion biased from the central portion can be accurately estimated by adding the wear amount A calculated based on the AE sensor having a large influence.

In addition, when calculating the wear amount A′ at each target portion, the wear amount estimation unit 106 may use a third AE sensor, in addition to the first AE sensor and the second AE sensor. The third AE sensor is an AE sensor provided at a bearing box that accommodates a bearing on a side opposite to the first AE sensor as viewed from the target portion. In this case, the third term corresponding to the third AE sensor is added to each equation described above, so that the wear amount A′ at each target portion can be calculated with higher accuracy.

The wear amount A′ of the central portion (LPC, IPC, HPC) of each of the casings 6a to 6c of the target portions is obtained by adding the wear amount A calculated by using a pair of AE sensors provided at a pair of bearing boxes that respectively accommodate bearings on both sides of the target portion, by using a predetermined weighting coefficient α. In each of Equations (4-2), (4-5), and (4-8) described above, the first term indicates a wear amount corresponding to one of the pair of AE sensors, and the second term indicates a wear amount corresponding to the other of the pair of AE sensors. In this manner, the wear amount A′ of the target portion at the central portion can be accurately estimated by adding the wear amount A calculated based on the pair of AE sensors having a large influence.

In the present embodiment, the wear amount A′ for each target portion is obtained by adding the wear amounts A estimated for each target portion. However, the wear amount A′ for each target portion may be obtained by adding the rubbing detection index a calculated for each target portion using the predetermined weighting coefficient α and integrating the addition result over the evaluation period.

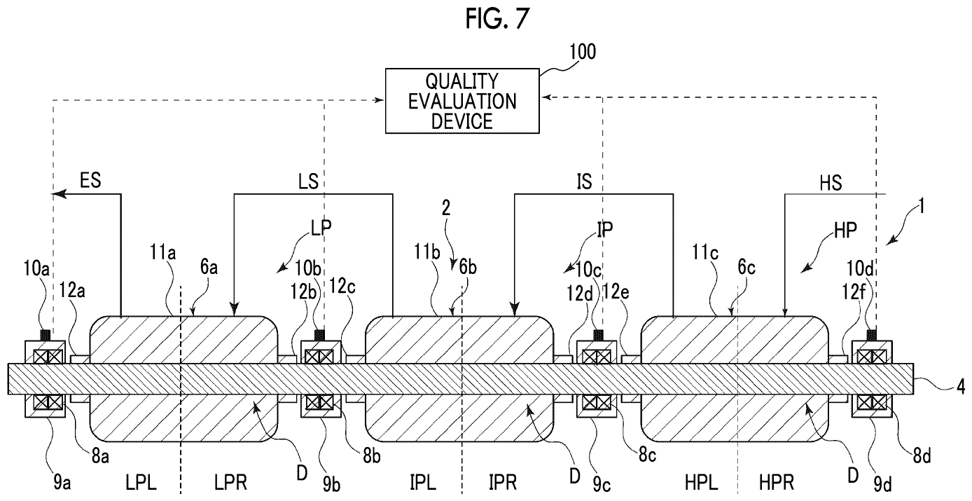

FIG. 7 is a cross-sectional structure diagram of the rotary machine 1 according to still another embodiment. This embodiment is different from the embodiment illustrated in FIG. 1 in that each of the plurality of AE sensors 10 is provided at each of the bearing boxes 9a to 9d. More specifically, the AE sensors 10a to 10d among the plurality of AE sensors 10 are respectively provided at the bearing boxes 9a to 9d. Each of the AE sensors 10 has the same configuration, and an AE signal detected by each AE sensor 10 can be acquired by the quality evaluation device 100.

In addition, in the embodiment illustrated in FIG. 7, a target portion at which a wear amount is to be estimated is set by dividing each of the casings 6a to 6c, which is the stationary portion 2, into two. Specifically, the left side portion LPL and the right side portion LPR are set as target portions in the casing 6a, the left side portion IPL and the right side portion IPR are set as target portions in the casing 6b, and the left side portion HPL and the right side portion HPR are set as target portions in the casing 6c.

The wear amount estimation unit 106 may estimate the wear amount A′ at each target portion by adding the wear amount A estimated by using each AE sensor 10 with a predetermined weighting coefficient. Specifically, the wear amount A′ in each target portion is represented by the following equations using wear amounts Aa to Ad estimated based on AE signals from the AE sensors 10a to 10d and the corresponding weighting coefficients αa to αd.

$$Wear amount {A}^{′} of target portion LPL = α a ( = 0.75 ) \times Aa + α b ( = 0.167 ) \times Ab \qquad Equation ( 5 - 1 )$$

$$Wear amount {A}^{′} of target portion LPR = α a ( = 0.25 ) \times Ab + α b ( = 0.33 ) \times Ab \qquad Equation ( 5 - 2 )$$

$$Wear amount {A}^{′} of target portion IPL = α b ( = 0.33 ) \times Ab + α c ( = 0.167 ) \times Ac \qquad Equation ( 5 - 3 )$$

$$Wear amount {A}^{′} of target portion IPR = α b ( = 0.167 ) \times Ab + α c ( = 0.33 ) \times Ac \qquad Equation ( 5 - 4 )$$

$$Wear amount {A}^{′} of target portion HPL = α c ( = 0.33 ) \times Ac + α d ( = 0.25 ) \times Ad \qquad Equation ( 5 - 5 )$$

$$Wear amount {A}^{′} of target portion HPR = α c ( = 0.167 ) \times Ac + α d ( = 0.75 ) \times Ad \qquad Equation ( 5 - 6 )$$

Each of the weighting coefficients αa to αd for each target portion is normalized such that each total is a predetermined value (for example, “1”).

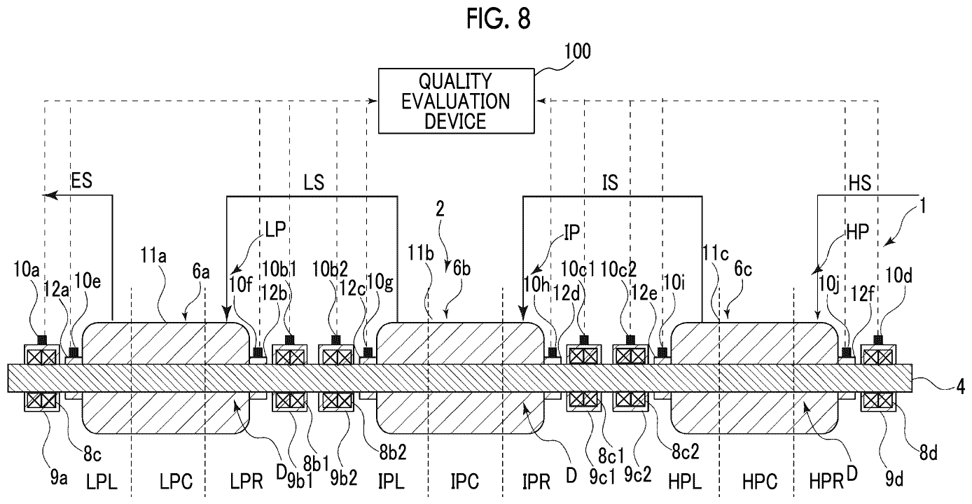

FIG. 8 is a cross-sectional structure diagram of the rotary machine 1 according to still another embodiment. In this embodiment, a pair of bearings 8b1 and 8b2 disposed along the axial direction are disposed instead of the bearing 8b between the casings 6a and 6b, and a pair of bearings 8cl and 8c2 disposed along the axial direction are disposed instead of the bearing 8c between the casings 6b and 6c, as compared with the embodiment illustrated in FIG. 1. The bearings 8b1 and 8b2 are accommodated in bearing boxes 9b1 and 9b2 independent of each other, respectively, and the bearings 8cl and 8c2 are accommodated in bearing boxes 9cl and 9c2 independent of each other, respectively. In addition, the difference is that each of the plurality of AE sensors 10 is provided at each of the bearing boxes 9a to 9d and the end portions 12a to 12f. More specifically, among the plurality of AE sensors 10, the AE sensors 10a to 10d are respectively provided at the bearing boxes 9a to 9d (sensors 10b1 and 10b2 are respectively provided at the bearing boxes 9b1 and 9b2, and sensors 10c1 and 10c2 are respectively provided at the bearing boxes 9cl and 9c2), and AE sensors 10g to 10j are respectively provided at the end portions 12a to 12f. Each of the AE sensors 10 has the same configuration, and an AE signal detected by each AE sensor 10 can be acquired by the quality evaluation device 100.

In addition, in the embodiment illustrated in FIG. 8, a target portion at which a wear amount is to be estimated is set by dividing each of the casings 6a to 6c, which is the stationary portion 2, into three. Specifically, the left side portion LPL, the central portion LPC, and the right side portion LPR are set as target portions in the casing 6a, the left side portion IPL, the central portion IPC, and the right side portion IPR are set as target portions in the casing 6b, and the left side portion HPL, the central portion HPC, and the right side portion HPR are set as target portions in the casing 6c.

The wear amount estimation unit 106 may estimate the wear amount A′ at each target portion by adding the wear amount A estimated by using each AE sensor 10 with a predetermined weighting coefficient. Specifically, the wear amount A′ in each target portion is represented by the following equations using wear amounts Aa to Al estimated based on AE signals from the AE sensors 10a to 101 and the corresponding weighting coefficients αa to αl.

$$Equation ( 6 - 1 )$$

$$Wear amount {A}^{′} of target portion LPL = α a ( = 0.5 ) \times Aa + α g ( = 1. ) \times Ag$$

$$Equation ( 6 - 2 )$$

$$Wear amount {A}^{′} of target portion LPC = α a ( = 0.5 ) \times Aa + α b ( = 0.5 ) \times Ab$$

$$Equation ( 6 - 3 )$$

$$Wear amount {A}^{′} of target portion LPR = α b ( = 0.5 ) \times Ab + α h ( = 1. ) \times Ah$$

$$Equation ( 6 - 4 )$$

$$Wear amount {A}^{′} of target portion IPL = α c ( = 0.5 ) \times Ab + α i ( = 1. ) \times Ai$$

$$Equation ( 6 - 5 )$$

$$Wear amount {A}^{′} of target portion IPC = α c ( = 0.5 ) \times Ac + α d ( = 0.5 ) \times Ad$$

$$Equation ( 6 - 6 )$$

$$Wear amount {A}^{′} of target portion IPR = α d ( = 0.5 ) \times Ad + α j ( = 1. ) \times Aj$$

$$Equation ( 6 - 7 )$$

$$Wear amount {A}^{′} of target portion HPL = α d ( = 0.5 ) \times Ad + α k ( = 1. ) \times Ak$$

$$Equation ( 6 - 8 )$$

$$Wear amount {A}^{′} of target portion HPC = α e ( = 0.5 ) \times Ae + α f ( = 0.5 ) \times Af$$

$$Equation ( 6 - 9 )$$

$$Wear amount {A}^{′} of target portion HPR = α f ( = 0.5 ) \times Af + α l ( = 1. ) \times Al$$

Each of the weighting coefficients αa to al for each target portion is normalized such that each total is a predetermined value (for example, “1”).

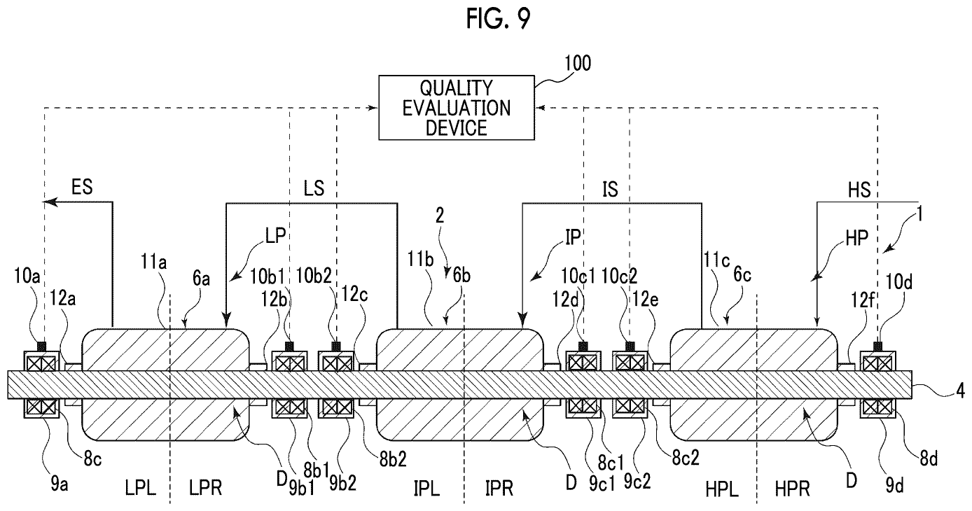

FIG. 9 is a cross-sectional structure diagram of the rotary machine 1 according to still another embodiment. This embodiment is different from the embodiment illustrated in FIG. 7 in that each of the plurality of AE sensors 10 is provided at each of the bearing boxes 9a to 9d. More specifically, among the plurality of AE sensors 10, the AE sensors 10a to 10d are respectively provided at the bearing boxes 9a to 9d (sensors 10b1 and 10b2 are respectively provided at the bearing boxes 9b1 and 9b2, and sensors 10c1 and 10c2 are respectively provided at the bearing boxes 9cl and 9c2). Each of the AE sensors 10 has the same configuration, and an AE signal detected by each AE sensor 10 can be acquired by the quality evaluation device 100.

In addition, in the embodiment illustrated in FIG. 9, a target portion at which a wear amount is to be estimated is set by dividing each of the casings 6a to 6c, which is the stationary portion 2, into two. Specifically, the left side portion LPL and the right side portion LPR are set as target portions in the casing 6a, the left side portion IPL and the right side portion IPR are set as target portions in the casing 6b, and the left side portion HPL and the right side portion HPR are set as target portions in the casing 6c.

The wear amount estimation unit 106 may estimate the wear amount A′ at each target portion by adding the wear amount A estimated by using each AE sensor 10 with a predetermined weighting coefficient. Specifically, the wear amount A′ in each target portion is represented by the following equations using wear amounts Aa to Af estimated based on AE signals from the AE sensors 10a to 10d and the corresponding weighting coefficients αa to αf.

$$Equation ( 7 - 1 )$$

$$Wear amount {A}^{′} of target portion LPL = α a ( = 0.75 ) \times Aa + α b ( = 0.25 ) \times Ab$$

$$Equation ( 7 - 2 )$$

$$Wear amount {A}^{′} of target portion LPR = α a ( = 0.25 ) \times Aa + α b ( = 0.75 ) \times Ab$$

$$Equation ( 7 - 3 )$$

$$Wear amount {A}^{′} of target portion IPL = α c ( = 0.75 ) \times Ac + α d ( = 0.25 ) \times Ad$$

$$Equation ( 7 - 4 )$$

$$Wear amount {A}^{′} of target portion IPR = α c ( = 0.25 ) \times Ac + α d ( = 0.75 ) \times Ad$$

$$Wear amount {A}^{′} of target portion HPL = α e ( = 0.75 ) \times Ae + α f ( = 0.25 ) \times Af \qquad Equation ( 7 - 5 )$$

$$Wear amount {A}^{′} of target portion HPR = α e ( = 0.25 ) \times Ae + α f ( = 0.75 ) \times Af \qquad Equation ( 7 - 6 )$$

Each of the weighting coefficients αa to αf for each target portion is normalized such that each total is a predetermined value (for example, “1”).

As described above, the wear amount estimation unit 106 can estimate the wear amount A′ at the target portion by integrating the rubbing detection index a for each target portion provided at different positions along the axial direction of the rotary portion 4. In this manner, it is possible to quantitatively ascertain the wear amount for each portion of the rotary machine, and it is possible to determine whether maintenance is required for each portion.

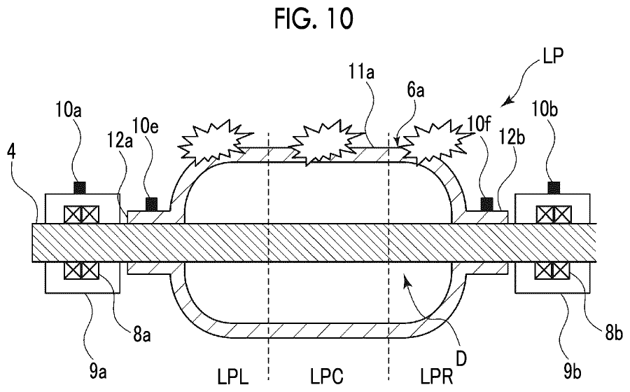

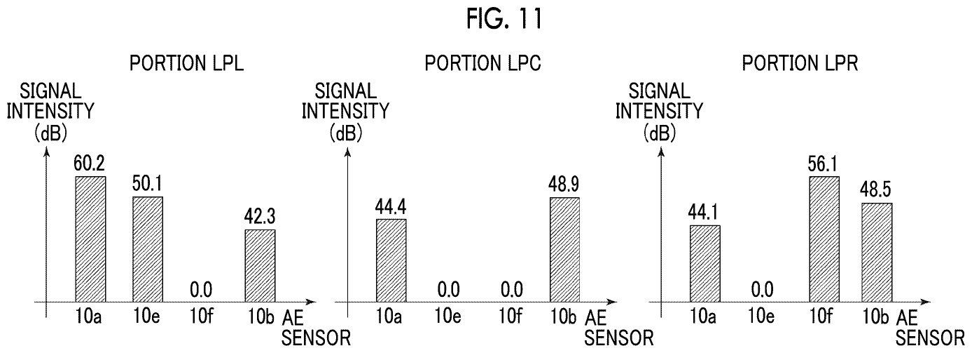

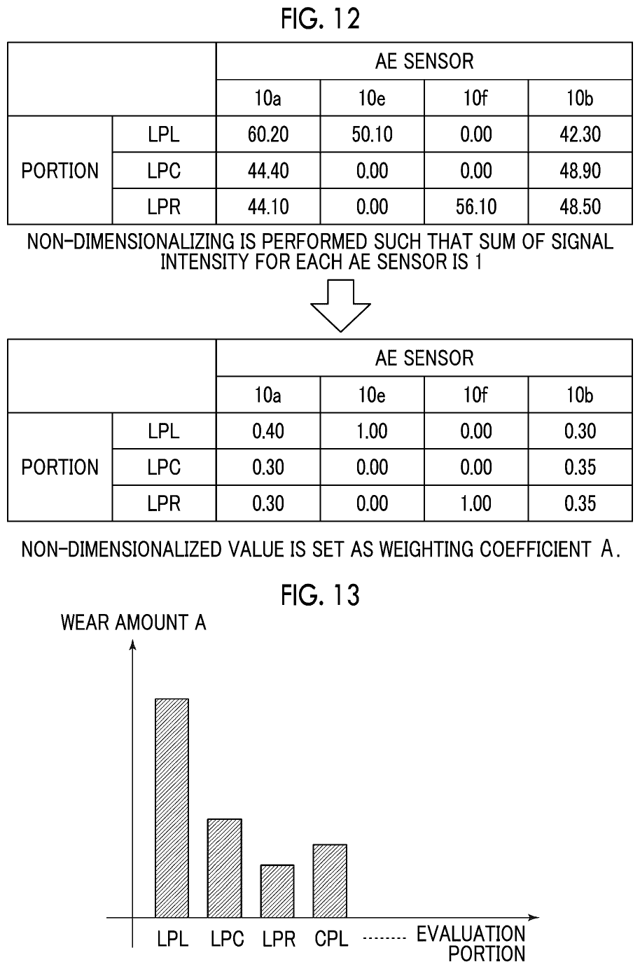

The weighting coefficient α used in the embodiment described above may be determined by actual measurement based on a response in a case where an impact is applied to the actual machine of the rotary machine 1 to be evaluated. FIG. 10 is a schematic view illustrating an enlarged view of a peripheral configuration of the low-pressure unit LP in FIG. 6, FIG. 11 is a view illustrating a signal intensity distribution obtained in a case where an impact is applied to each target portion in FIG. 10, and FIG. 12 is an example of calculating the weighting coefficient α based on the signal intensity in FIG. 11.

The impact applied to the target portion may be applied from an inside to a casing which is the stationary portion 2. In the actual rotary machine 1, rubbing occurs due to the rotary portion 4 coming into contact with the stationary portion 2 from the inside. Therefore, by applying the impact from the inside of the casing, it is possible to appropriately simulate a situation in which rubbing actually occurs.

In this case, as illustrated in FIG. 10, an impact is applied to each position corresponding to each target portion (LPL, LPC, LPR), and at that time, the weighting coefficient α is determined based on a signal intensity distribution of the AE signals obtained by the plurality of AE sensors 10. In FIG. 11, the signal intensity distribution obtained by each AE sensor 10 for each target portion to which the impact is applied in FIG. 10 is illustrated.

Specifically, in a case where an impact is applied to the target portion LPL, the AE sensor 10a (corresponding to the first AE sensor described above) provided at the bearing box 9a closest to the target portion LPL can obtain the highest signal intensity. Next, the AE sensor 10e (corresponding to the second AE sensor described above) provided at the end portion 12a of the casing 6a between the target portion LPL and the bearing box 9a obtains the next highest signal intensity. Next, the next highest signal intensity is obtained in the AE sensor 10b (corresponding to the third AE sensor described above) provided at the bearing box 9b that accommodates the bearing 8b on a side opposite to the AE sensor 10a when viewed from the target portion LPL. Meanwhile, the AE sensor 10f obtains hardly any signal intensity.

In a case where an impact is applied to the target portion LPC, a high signal intensity is obtained in a pair of AE sensors 10a and 10b respectively provided at a pair of bearing boxes 9a and 9b that respectively accommodate the bearings 8a and 8b on both sides of the target portion LC. Meanwhile, the AE sensors 10e and 10f obtain hardly any signal intensity.

In a case where an impact is applied to the target portion LPR, the AE sensor 10f provided at an end portion 12b closest to the target portion LPR can obtain the highest signal intensity. Next, the AE sensor 10b (corresponding to the first AE sensor described above) provided at the bearing box 9b at an end portion closest to the target portion LPR can obtain the highest signal intensity. Next, the next highest signal intensity is obtained in the AE sensor 10a (corresponding to the third AE sensor described above) provided at the bearing box 9a that accommodates the bearing 8a on a side opposite to the AE sensor 10b when viewed from the target portion LPR. Meanwhile, the AE sensor 10e obtains hardly any signal intensity.

FIG. 12 illustrates an example of calculating the weighting coefficient α based on the signal intensity distribution illustrated in FIG. 11. In this example, the weighting coefficient α is calculated by non-dimensionalizing a ratio of the signal intensity of each AE sensor 10 for each target portion illustrated in the upper part. In this manner, in the present embodiment, for example, a situation in which rubbing occurs due to the rotary portion 4 coming into contact with the stationary portion 2 at the target portion is simulated and reproduced by a worker manually applying an impact to the target portion. At this time, the signal intensity distribution of the AE signals obtained by the plurality of AE sensors 10 reflects which AE signal is obtained by each AE sensor 10 when rubbing occurs at the target portion. Therefore, the wear amount A of the rotary machine 1 that is obtained by integrating the AE signals detected by the plurality of AE sensors 10 can be more accurately estimated by calculating the weighting coefficient α based on the signal intensity distribution.

As described above, in a case where the wear amount A is estimated for each target portion by the wear amount estimation unit 106, a size of damage can be evaluated for each target portion of the rotary machine 1, by comparing the estimation values of the wear amount A for each target portion. FIG. 13 is a diagram illustrating an example of an estimation value of the wear amount A for each target portion of the rotary machine 1. In the example in FIG. 13, particularly, since the wear amount A of the target portion LPL illustrated on the leftmost side is the largest, it is possible to determine that only the target portion LPL corresponding to the wear amount A should be opened and inspected at the time of performing maintenance.

In addition, as illustrated in FIG. 13, by checking a magnitude of the wear amount A for each target portion, it is possible to secure a component for which replacement work is expected in the next maintenance in advance. In this manner, it is possible to reduce waiting time for securing the replacement component, and thus it is possible to improve cost efficiency or the time required for the maintenance.

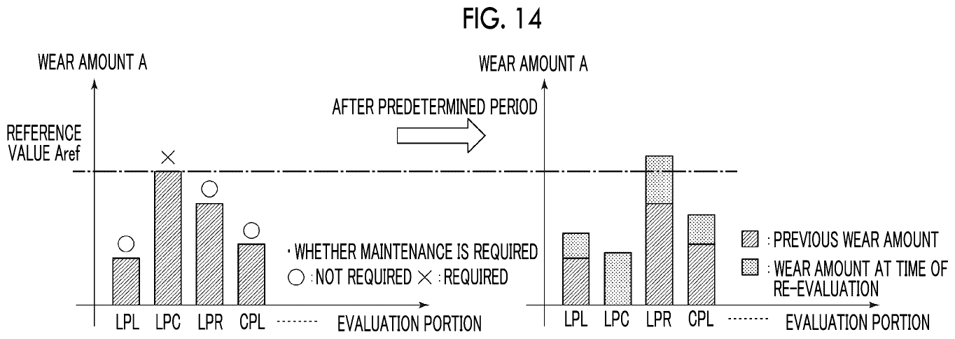

In addition, when there is an existing inspection record, the reference value Aref for determining whether maintenance is required may be determined from an estimation value of the wear amount A based on the inspection record. FIG. 14 is an explanatory diagram illustrating a state in which the reference value Aref for determining whether maintenance is required is determined from the existing inspection result.

In FIG. 14, an example of an existing inspection result is illustrated on the left side. In this inspection result, a result is obtained that maintenance is required since the wear amount A is large in the target portion LPC, among the plurality of target portions. Based on such an inspection result, the wear amount (actual measurement value) of the target portion LPC of the inspection result can be determined as the reference value Aref. The reference value Aref determined in this manner can be used for determining whether maintenance is required, based on the estimation value of the wear amount A in the next and subsequent times, as illustrated on the right side in FIG. 14. In this example, since the wear amount A at the time of re-evaluation of the target portion LPR exceeds the reference value Aref, it can be predicted that component replacement of the target portion LPR is required at the next maintenance.

In addition, the weighting coefficient α used in each of the embodiments described above may be corrected based on the actually measured result at the time of maintenance. For example, in a case where there is a target portion at which the estimation value of the wear amount A is small but the wear amount A is large in the actually measured inspection result, the weighting coefficient α corresponding to the AE sensor 10 can be corrected to be increased on the assumption that a sensitivity of the AE sensor 10 is low at the target portion. On the other hand, in a case where there is a target portion at which the estimation value of the wear amount A is large but the wear amount A is small in the actually measured inspection result, the weighting coefficient α corresponding to the AE sensor 10 can be corrected to be decreased on the assumption that the sensitivity of the AE sensor 10 is high at the target portion.

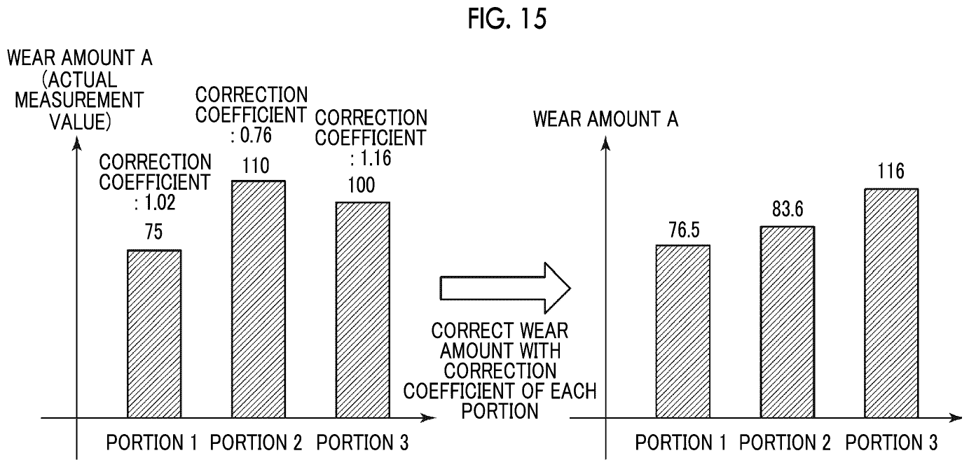

FIG. 15 is an explanatory diagram illustrating a correction example of the weighting coefficient based on an inspection result. In FIG. 15, the wear amount A, which is an actual measurement value obtained by an inspection result for each target portion, is illustrated on the left side, and an estimation value of the wear amount A for each target portion is illustrated on the right side. On the left side of this example, an average wear amount of each evaluation portion is calculated from the inspection result, and a correction coefficient for correcting the weighting coefficient α is calculated by non-dimensionalizing a total value of each portion. On the other hand, on the right side, the estimation value of the wear amount A is non-dimensionalized by the total value of each target portion. When the weighting coefficient α is corrected, a deviation between the non-dimensionalized inspection result and the non-dimensionalized estimation value of the wear amount A can be obtained by taking a ratio therebetween. Therefore, the ratio is used as a correction coefficient for the weighting coefficient α, and the inspection result is reflected. In this manner, estimation accuracy of the wear amount A can be improved.

In addition, it is possible to appropriately replace the components in the embodiments described above with well-known components within the scope which does not depart from the gist of the present disclosure, and the embodiments described above may be combined as appropriate.

The contents described in each embodiment described above are understood as follows, for example.

(1) According to one aspect, there is provided a quality evaluation device for a rotary machine for evaluating a quality of the rotary machine having a rotary portion that is rotatably supported to a stationary portion by a bearing, the device including:
an AE signal acquisition unit for acquiring an AE signal from at least one AE sensor provided at the stationary portion;
a rubbing detection index calculation unit for calculating a rubbing detection index based on the AE signal; and
a wear amount estimation unit for estimating a wear amount of the rotary machine by integrating the rubbing detection index.

With the aspect (1) described above, the rubbing detection index is calculated based on the AE signal acquired from the AE sensor provided at the stationary portion, and the wear amount occurring in the rotary machine due to rubbing occurrence can be appropriately estimated by integrating the rubbing detection index. The rubbing detection index that is integrated to calculate the wear amount can broadly include an index for determining the presence or absence of instantaneous rubbing occurrence.

(2) In another aspect, the aspect (1) described above further includes:
a determination unit for determining whether maintenance of the rotary machine is required, by comparing the wear amount with a preset reference value.

With the aspect (2) described above, the wear amount quantitatively calculated by integrating the rubbing detection index is compared with the preset reference value. As a result, in a case where it is determined that the wear amount of the rotary machine is sufficiently large since the wear amount exceeds the reference value, it is possible to appropriately determine that maintenance of the rotary machine is required.

(3) In still another aspect, in the aspect (1) or (2) described above,
by integrating the rubbing detection index for each target portion provided at a different position along an axial direction of the rotary portion, the wear amount estimation unit estimates the wear amount at the target portion.

With the aspect (3) described above, the wear amount is estimated by integrating the rubbing detection index for each target portion provided at a different position along the axial direction of the rotary portion. In this manner, it is possible to quantitatively ascertain the wear amount for each portion of the rotary machine, and it is possible to determine whether maintenance is required for each portion.

(4) In still another aspect, in any one of the aspects (1) to (3) described above,
the wear amount estimation unit estimates the wear amount, by integrating the rubbing detection index over a region in which the rubbing detection index exceeds a preset threshold value.

With the aspect (4) described above, the rubbing detection index is integrated over a region determined to have rubbing occurrence due to the rubbing detection index exceeding the threshold value, and thus the wear amount can be appropriately estimated.

(5) In still another aspect, in any one of the aspects (1) to (3) described above,
the wear amount estimation unit estimates the wear amount, by integrating a time when the rubbing detection index exceeds a preset threshold value.

With the aspect (5) described above, the wear amount can be appropriately estimated by integrating the time in which the rubbing detection index exceeds the threshold value.

(6) In still another aspect, in any one of the aspects (1) to (5) described above,
the at least one AE sensor includes a plurality of AE sensors, and
the wear amount estimation unit estimates the wear amount, by adding the rubbing detection index calculated based on the AE signal from the plurality of AE sensors by using a weighting coefficient.

With the aspect (6) described above, the rubbing detection index which is used for estimating the wear amount by integration is obtained by adding the AE signals detected by the plurality of AE sensors by using the weighting coefficient. By using a plurality of AE signals detected by the plurality of AE sensors in this manner, the wear amount can be more accurately estimated, as compared with a case where only an AE signal detected by a single AE sensor is used.

(7) In still another aspect, in the aspect (6) described above,
in a case where a target portion at which the wear amount is to be estimated is biased to one side of a central portion of a casing which accommodates the rotary portion in the stationary portion, the plurality of AE sensors include a first AE sensor provided at a bearing box which accommodates the bearing at a position closest to the target portion, and a second AE sensor provided at an end portion of the casing between the target portion and the bearing box.

With the aspect (7) described above, in a case where there is a target portion at which the wear amount is to be estimated at a position biased to one side from the central portion of the casing, the wear amount is estimated based on the AE signal detected by each of the first AE sensor and the second AE sensor. The first AE sensor is provided at the bearing box at the position closest to the target portion, and the second AE sensor is provided between the target portion and the bearing box at which the first AE sensor is provided. Since the AE sensors are provided at positions at which a sensitivity to the target portion biased to one side from the central portion of the casing is good, the wear amount at the target portion can be accurately estimated by using the AE signal detected by the AE sensors.

(8) In still another aspect, in the aspect (7) described above,
the plurality of AE sensors include a third AE sensor provided at a bearing box which accommodates the bearing on a side opposite to the first AE sensor when viewed from the target portion.

With the aspect (8) described above, in a case where there is a target portion at which the wear amount is to be estimated at a position biased to one side from the central portion of the casing, the wear amount is further estimated based on the AE signal detected by the third AE sensor. The third AE sensor is provided at another bearing box that is on a side opposite to the bearing box at which the first AE sensor is provided and through which the AE signal is likely to propagate via the rotary portion. In this manner, the wear amount at the target portion can be more accurately estimated by further using the AE signal detected by the third AE sensor.

(9) In still another aspect, in any one of the aspects (6) to (8) described above,
in a case where a target portion at which the wear amount is to be estimated is a central portion of a casing which accommodates the rotary portion, the plurality of AE sensors include a pair of AE sensors respectively provided at a pair of bearing boxes which respectively accommodate the bearing on both sides of the target portion.

With the aspect (9) described above, in a case where there is a target portion at which the wear amount is to be estimated in the central portion of the casing, the wear amount is estimated based on the AE signal detected by each of the pair of AE sensors provided at the bearing boxes on both sides of the central portion. Since the AE sensors are provided at positions at which a sensitivity to the target portion in the central portion of the casing is good, the wear amount in the target portion can be accurately estimated by using the AE signal detected by the AE sensors.

(10) In still another aspect, in any one of the aspects (6) to (9) described above,
the weighting coefficient is calculated based on a signal intensity distribution of the AE signal obtained by the plurality of AE sensors in a case where an impact is applied to a target portion at which the wear amount is to be estimated.

With the aspect (10) described above, for example, a situation in which rubbing occurs due to the rotary portion coming into contact with the stationary portion at the target portion and a worker manually applying the impact to the target portion is simulated and reproduced. At this time, the signal intensity distribution of the AE signals obtained by the plurality of AE sensors reflects which AE signal is obtained by each AE sensor when rubbing occurs at the target portion. Therefore, the wear amount of the rotary machine that is obtained by integrating the AE signals detected by the plurality of AE sensors can be more accurately estimated by calculating the weighting coefficient based on the signal intensity distribution.

(11) In still another aspect, in the aspect (10) described above,
the impact is applied from an inside to the stationary portion.

With the aspect (11) described above, by applying the impact from the inside of the stationary portion, it is possible to appropriately simulate the situation in which rubbing occurs due to the rotary portion coming into contact with the stationary portion from the inside. The wear amount of the rotary machine can be accurately estimated by calculating the weighting coefficient based on the signal intensity distribution of the AE signal detected by the AE sensor when such an impact is applied.

(12) In still another aspect, in any one of the aspects (6) to (11),
the weighting coefficient is corrected, based on an actual measurement value of the wear amount measured for each target portion provided at a different position along an axial direction of the rotary portion.

With the aspect (12) described above, for example, the weighting coefficient used for estimating the wear amount is corrected based on the actual measurement value obtained by opening the rotary machine and measuring the wear amount for each target portion during maintenance. By using the weighting coefficient corrected based on the actual measurement value in this manner, estimation accuracy of the wear amount thereafter can be effectively improved.

(13) In still another aspect, in any one of the aspects (1) to (12) described above,
the rubbing detection index is calculated based on information on a phase of the AE signal.

With the aspect (13) described above, the wear amount of the rotary machine can be appropriately estimated by integrating the rubbing detection index calculated based on the information on the phase of the AE signal. For example, the AE signal detected by the AE sensor includes a noise signal from the rotary portion such as a turbine during an operation of the rotary machine to some extent. Even in a case where the noise signal is relatively large, the rubbing detection index calculated based on the information on the phase of the AE signal can be used to appropriately determine the presence or absence of rubbing occurrence.

(14) In still another aspect, in the aspect (13) described above,
the rubbing detection index is calculated by the following equation,

$$rubbing detection index = 1 / ( 1 + ( variance in phase of AE signal ) \hat{} 0.5 .$$

With the aspect (14) described above, by using the rubbing detection index defined by the equation described above, it is possible to determine the presence or absence of rubbing occurrence based on the AE signal including a relatively large noise signal, and it is possible to appropriately estimate the wear amount of the rotary machine by integrating the rubbing detection index.

(15) According to still another aspect, there is provided a quality evaluation method for a rotary machine for evaluating a quality of the rotary machine having a rotary portion that is rotatably supported to a stationary portion by a bearing, the method including:
a step of acquiring an AE signal from at least one AE sensor provided at the stationary portion;
a step of calculating a rubbing detection index based on the AE signal; and
a step of estimating a wear amount of the rotary machine by integrating the rubbing detection index.

With the aspect (15) described above, the rubbing detection index is calculated based on the AE signal acquired from the AE sensor provided at the stationary portion, and the wear amount occurring in the rotary machine due to rubbing occurrence can be appropriately estimated by integrating the rubbing detection index. The rubbing detection index that is integrated to calculate the wear amount can broadly include an index for determining the presence or absence of instantaneous rubbing occurrence.

(16) According to still another aspect, there is provided a quality evaluation program for a rotary machine for evaluating a quality of the rotary machine having a rotary portion that is rotatably supported to a stationary portion by a bearing, the program causing a computer device to execute:
a step of acquiring an AE signal from at least one AE sensor provided at the stationary portion;
a step of calculating a rubbing detection index based on the AE signal; and
a step of estimating a wear amount of the rotary machine by integrating the rubbing detection index.

With the aspect (16) described above, the rubbing detection index is calculated based on the AE signal acquired from the AE sensor provided at the stationary portion, and the wear amount occurring in the rotary machine due to rubbing occurrence can be appropriately estimated by integrating the rubbing detection index. The rubbing detection index that is integrated to calculate the wear amount can broadly include an index for determining the presence or absence of instantaneous rubbing occurrence.

### REFERENCE SIGNS LIST

1 rotary machine
2 stationary portion
4 rotary portion
LP low-pressure unit
IP intermediate-pressure unit
HP high-pressure unit
8a to 8d bearing
9a to 9d bearing box
10 AE sensor
11a to 11c central portion
12a to 12f end portion
100 quality evaluation device
102 AE signal acquisition unit
104 rubbing detection index calculation unit
106 wear amount estimation unit
108 determination unit
D gap

1. A quality evaluation device for a rotary machine for evaluating a quality of the rotary machine having a rotary portion that is rotatably supported to a stationary portion by a bearing, the device comprising:
an AE signal acquisition unit for acquiring an AE signal from at least one AE sensor provided at the stationary portion;
a rubbing detection index calculation unit for calculating a rubbing detection index based on the AE signal; and
a wear amount estimation unit for estimating a wear amount of the rotary machine by integrating the rubbing detection index.

2. The quality evaluation device for a rotary machine according to claim 1, further comprising:
a determination unit for determining whether maintenance of the rotary machine is required, by comparing the wear amount with a preset reference value.

3. The quality evaluation device for a rotary machine according to claim 1,
wherein by integrating the rubbing detection index for each target portion provided at a different position along an axial direction of the rotary portion, the wear amount estimation unit estimates the wear amount at the target portion.

4. The quality evaluation device for a rotary machine according to claim 1,
wherein the wear amount estimation unit estimates the wear amount, by integrating the rubbing detection index over a region in which the rubbing detection index exceeds a preset threshold value.

5. The quality evaluation device for a rotary machine according to claim 1,
wherein the wear amount estimation unit estimates the wear amount, by integrating a time when the rubbing detection index exceeds a preset threshold value.

6. The quality evaluation device for a rotary machine according to claim 1,
wherein the at least one AE sensor includes a plurality of AE sensors, and
the wear amount estimation unit estimates the wear amount, by adding the rubbing detection index calculated based on the AE signal from the plurality of AE sensors by using a weighting coefficient.

7. The quality evaluation device for a rotary machine according to claim 6,
wherein in a case where a target portion at which the wear amount is to be estimated is biased to one side of a central portion of a casing which accommodates the rotary portion in the stationary portion, the plurality of AE sensors include a first AE sensor provided at a bearing box which accommodates the bearing at a position closest to the target portion, and a second AE sensor provided at an end portion of the casing between the target portion and the bearing box.

8. The quality evaluation device for a rotary machine according to claim 7,
wherein the plurality of AE sensors include a third AE sensor provided at a bearing box which accommodates the bearing on a side opposite to the first AE sensor when viewed from the target portion.

9. The quality evaluation device for a rotary machine according to claim 6,
wherein in a case where a target portion at which the wear amount is to be estimated is a central portion of a casing which accommodates the rotary portion, the plurality of AE sensors include a pair of AE sensors respectively provided at a pair of bearing boxes which respectively accommodate the bearing on both sides of the target portion.

10. The quality evaluation device for a rotary machine according to claim 6,
wherein the weighting coefficient is calculated based on a signal intensity distribution of the AE signal obtained by the plurality of AE sensors in a case where an impact is applied to a target portion at which the wear amount is to be estimated.

11. The quality evaluation device for a rotary machine according to claim 10,
wherein the impact is applied from an inside to the stationary portion.

12. The quality evaluation device for a rotary machine according to claim 6,
wherein the weighting coefficient is corrected, based on an actual measurement value of the wear amount measured for each target portion provided at a different position along an axial direction of the rotary portion.

13. The quality evaluation device for a rotary machine according to claim 1,
wherein the rubbing detection index is calculated based on information on a phase of the AE signal.

14. The quality evaluation device for a rotary machine according to claim 13,
wherein the rubbing detection index is calculated by the following equation,
rubbing detection index=1/(1+(variance in phase of AE signal)\hat{ }0.5).

15. A quality evaluation method for a rotary machine for evaluating a quality of the rotary machine having a rotary portion that is rotatably supported to a stationary portion by a bearing, the method comprising:
a step of acquiring an AE signal from at least one AE sensor provided at the stationary portion;
a step of calculating a rubbing detection index based on the AE signal; and
a step of estimating a wear amount of the rotary machine by integrating the rubbing detection index.

16. A quality evaluation program for a rotary machine for evaluating a quality of the rotary machine having a rotary portion that is rotatably supported to a stationary portion by a bearing, the program causing a computer device to execute:
a step of acquiring an AE signal from at least one AE sensor provided at the stationary portion;
a step of calculating a rubbing detection index based on the AE signal; and
a step of estimating a wear amount of the rotary machine by integrating the rubbing detection index.
